(19) United States
(12) Patent Application Publication
(10) Pub. No.: US 2016/0048519 A1
(43) Pub. Date: Feb. 18, 2016

(54) A RANKING SYSTEM

(71) Applicant: Wesley Seng Chew Chew, Penang (MY)

(72) Inventor: WESLEY SENG CHEW CHUAH, PENANG (MY)

(21) Appl. No.: 14/782,430

(22) PCT Filed: Mar. 27, 2014
(86) PCT No.: PCT/MY2014/000041

§ 371 Date: Oct. 5, 2015

(30) Foreign Application Priority Data
Apr. 3, 2013 (MY) PI 2013001185

(51) Int. Cl. G06F 17/30

(52) U.S. Cl. CPC G06F 17/3053; G06F 17/30876; G06F 17/3089; G06F 17/30867

(57) ABSTRACT

This disclosure describes a system (116) for ranking a plurality of items comprising an online platform capable of displaying at least a list showing ranking of the items; a voting link generating module for generating a voting link (110) that is assigned to a specific item to allow a vote to be cast (102) thereon following a specific action (112) performed on the voting link (110); a ranking engine for determining ranking of the items (107) through updating and/or repositioning the items on the list upon receiving the vote; and one or more servers having at least one processor for managing processes executed by the system (116); wherein the voting link (110) is configured to be inserted and displayed on a third-party platform (111) managed by a third-party server to readily interact and receive the specific action (112) for the vote to be cast on the item from one or more users browsing the third-party platform (111) without having the user to visit the online platform of the system (116).

### FIELD OF INVENTION

The disclosure below relates to a ranking system that is integrated with a voting system which allows voting activity to be performed on a third-party platform that is administered by a third-party server.

### BACKGROUND OF THE INVENTION

The fast developing technology sees the emergence of various voting systems used to determine rankings for identifying and tracking the popularity or preferences of a certain population towards a subject. Several online ranking platforms are integrated with tailored voting solutions that are designed to meet specific requirements of different types of organization. For instance, brand ranking platforms provide voting system to examine the effect and favoritism of the public on a choice or a brand. Such voting system reflects responses of the public towards a brand, and the rankings provide at-a-glance answers to questions on the popularity of brands in an industry.

Most existing online ranking platforms come in the form of a voting-enabled website which displays rankings of various categories. Voting modules are available on the website for visitors of the website to select a choice from a list. Once a selection is made, the rankings would be updated to exhibit the latest voting results. Such voting systems work like a conventional online poll system. A prior art employing similar method in producing rankings is described in EP 2126722. The system of this patent is a digital content hosting web site having a user interface for displaying a set of digital content items to be collaboratively ranked. The user interface comprises a plurality of digital content rows, wherein each digital content row has a ranking cell displaying a relative ranking position of the digital content item associated with the row. Voting of a digital content could be done through clicking on a first button adapted to increase a ranking position of the digital content item. Conversely, a second button is adapted to decrease a ranking position of a digital content. There is an element adapted to display the numerical change of ranking positions for the digital content.

Whilst registration is not compulsory for most of these systems, ranking platforms which values the accountability of the results requires voter authentication. Some platforms even assign weights for votes depending on the voter's identity or status in its platform. An example of such system that collects online votes is disclosed in EP2174220. The system comprises a server connected to a network, a database connected to the server, and a voter computer connected to the network. The voter computer is configured to register with the server using a profile prior to being able to make a selection among a plurality of options given by the server. The database stores information concerning past activity associated with a voter profile. The past activities associated to the voter profile are used to determine the value of the vote cast by the user of the voter computer.

The major limitation of the prior arts described above is that voters are required to visit the online platform such as the website in order to cast their votes. Voters are required to know the address of the platform or conduct a search on the search engines in order to locate the platform. Else, a lot of effort is needed to create awareness of the existence of the platform to direct traffic to it. By having the voting system available only in the platform, there is a high possibility that internet users would find it inconvenient and hence not interested in visiting the platform for casting vote. Such voting and ranking system causes the credibility of the ranking results to be questionable, especially for little known platforms having limited visitors as the results would only reflect the choices of a small amount of people, and therefore not be applicable to represent the responses of a large population towards the choices. Moreover, creation of brand awareness via such brand ranking platforms which also serve as a brand centric website for brand owners to promote their brands would fail with such little traffic visiting the platform.

This disclosure aims to provide a solution to the drawbacks of current ranking platforms through enabling voting to be conducted via a variety of channels. Such system is targeted on brand centric websites which provides indication on the popularity of brands through its ranking system which would lead to the enhancement of global presence and awareness of the brands listed on the websites.

### SUMMARY OF INVENTION

One aspect of this disclosure is to provide a ranking system which allows voting to be conducted via a voting link embedded on third-party platforms such as emails and websites including forums, social network and blogs.

Another aspect of this disclosure is to provide a ranking system with a voting mechanism which is flexible, convenient, accurate and accountable that deters fraud voters.

Still another aspect of this disclosure is to provide a ranking system with a voting mechanism which implements value voting method.

Yet another aspect of this disclosure is to provide a ranking system which is a reliable measurement for popularity of a choice such as a brand.

Also another aspect of this disclosure is to provide a ranking system which comprises a brand centric online platform for owners to promote their brands and interact with users.

At least one of the preceding aspects is met, in whole or in part, by this disclosure, in which the embodiment of this disclosure describes a system (116) for ranking a plurality of items comprising an online platform capable of displaying at least a list showing ranking of the items; a voting link generating module for generating a voting link (110) that is assigned to a specific item to allow a vote to be cast (102) thereon following a specific action (112) performed on the voting link (110); a ranking engine for determining ranking of the items (107) through updating and/or repositioning the items on the list upon receiving the vote; and one or more servers having at least one processor for managing processes executed by the system (116); wherein the voting link (110) is configured to be inserted and displayed on a third-party platform (111) managed by a third-party server to readily interact and receive the specific action (112) for the vote to be cast on the item from one or more users browsing the third-party platform (111) without having the user to visit the online platform of the system (116).

In addition to that, this disclosure also describes a method for ranking a plurality of items using a system (116) having one or more servers that includes at least one processor for managing processes executed by the system (116) comprising the steps of casting a vote that is assigned to an item (101) by a user through performing a specific action (112) on a voting link (110) inserted and displayed on a third-party platform (111) which is managed by a third-party server; determining a list showing rankings of a plurality of items (107) by a ranking engine of the system (116) through updating and/or repositioning the items on the list upon receiving the vote; and displaying the list (108) on an online platform of the system (116); wherein the voting link (110) which is generated by a voting link generating module is configured to readily interact and receive the specific action (112) for the vote to be cast on the item from one or more users browsing the third-party platform without having the user to visit the online platform of the system (116).

### BRIEF DESCRIPTION OF THE DRAWINGS

FIG. 1 shows a ranking process of an item.

FIG. 2 shows an exemplary method to display a voting link on a third-party platform that links to the system.

FIG. 3 shows a voting process performed on the third-party platform.

FIG. 4 shows a voting process performed on the online platform of the system.

FIG. 5 shows an example of user points gained through different types of user activity performed on the system.

FIG. 6 shows an example of user points lost through different user activities performed on the system.

FIG. 7 shows an example of user points gained through user creditability.

### DETAILED DESCRIPTION OF THE INVENTION

This disclosure describes a system (116) for ranking a plurality of items comprising an online platform capable of displaying at least a list showing ranking of the items; a voting link generating module for generating a voting link (110) that is assigned to a specific item to allow a vote to be cast (102) thereon following a specific action (112) performed on the voting link (110); a ranking engine for determining ranking of the items (107) through updating and/or repositioning the items on the list upon receiving the vote; and one or more servers having at least one processor for managing processes executed by the system (116); wherein the voting link (110) is configured to be inserted and displayed on a third-party platform (111) managed by a third-party server to readily interact and receive the specific action (112) for the vote to be cast on the item from one or more users browsing the third-party platform (111) without having the user to visit the online platform of the system (116).

The type of items are not restricted but preferred to be brands of services and products as well as public figures, in which they are categorized according to certain criteria, such as the nature or intended purposes of the products and services; or in the case of public figures, the field, geographical locality or age range of the figures. Positioning of the items on the list (hereinafter referred to as ‘ranking list’) is based on votes cast by users. The term ‘user’ used herein indicates an individual who is a participant in the determination of the ranking results and/or a participant in the user activity provided on the online platform of the system (116). Therefore, the ‘third party’ having a voting link (110) on his platform (111) is also a user of the system (116). The online platform could be a website or a mobile application that allows user activities to be carried out. It should be noted that the term ‘websites’ include forums, social networking sites, blogs and the like that are accessible through a browser application which uses any form of web based language and is configured to receive and display graphics, multimedia and text. The servers that are computers having at least one processor are used for administering and executing functions of the engines, modules and online platform to run processes of the system (116). The servers also include memory for data storage and a network interface unit for enabling the computer to connect to the network. An interface generating module can also be included in the system (116) for generating data to be displayed on the interface of the online platform.

In the preferred embodiment, the system (116) provides an online platform having interfaces that display multiple ranking lists for various categorized items (108). The ranking lists are consistently updated within a predetermined time according to the amount of votes received for each items. Real time update is preferred for users to keep track of the items that are trending the rankings. Such feature allows users to identify the positioning of items based on their popularity among users. Consistent leaders of each category could be determined through the ranking lists which act as a leaderboard for items such as brands and public figures. For an item to be listed on the ranking list as a registered item of the system (116), the item owner can either subscribe to the services of the system (116) or be invited by the system (116) to take part in the rankings.

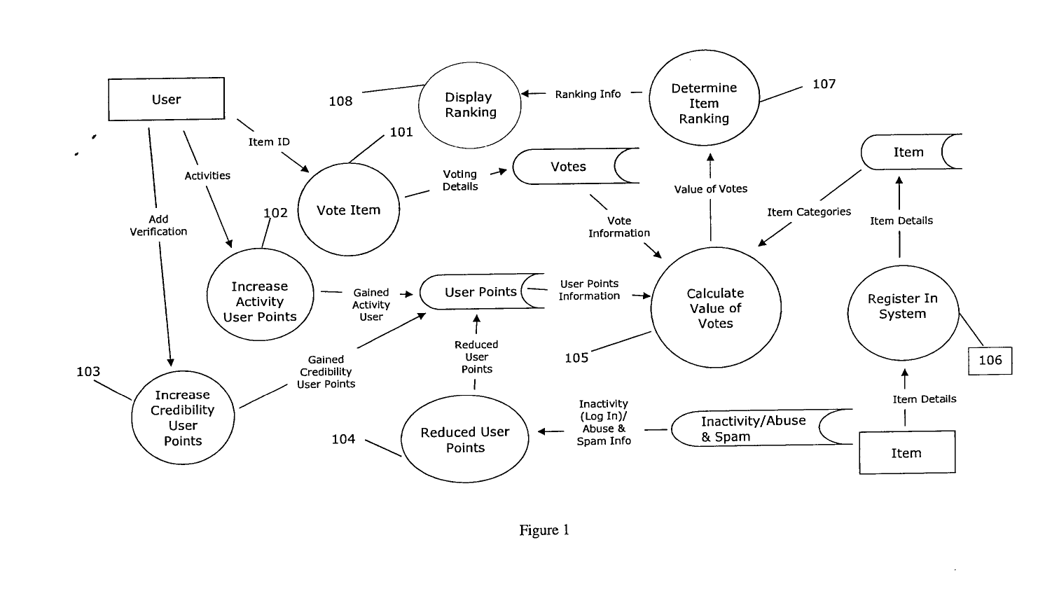

FIG. 1 illustrates an overall ranking process of the preferred embodiment of this disclosure, whereby the ranking results depend on votes cast by users. Preferably, the votes are each assigned a value in accordance with the user points gained or lost through activities and credibility of the users. The major feature of this disclosure lies on the voting system (116) that allows voting (101) to be performed not only on the online platform itself but also on third-party platforms (111) that are managed by third-party servers. The third-party platform (111) referred herein includes any one or a combination of a website, email application or mobile application. These third-party platforms (111) do not belong to the system (116) but are administered or possessed by the owners of the items, such as the public figure himself or a proprietor of a brand. Owners are provided with the voting link (110) assigned to their items upon registering an account (106) in the system (116). By having a voting link (110) embedded on the interfaces of the third-party platforms (111), users can conveniently cast their vote (101) through the voting link (110). Such feature also helps to direct users to the online platform of the system (116) from the third-party platforms (111) for them to view the ranking results and participate in other activities provided on the online platform.

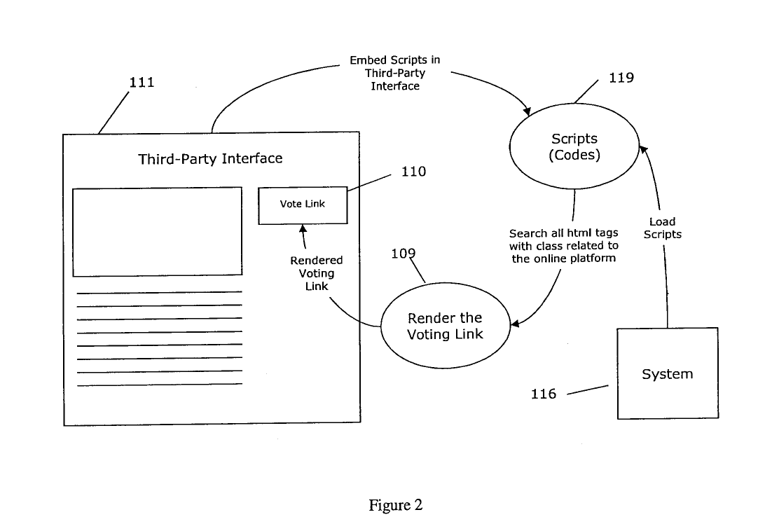

As depicted in FIG. 2, the preferred way to have the voting link (110) displayed on a third-party platform (111) is through embedding a script code (119) into the third-party (111) platform. The code is in the form of JavaScript and is embedded in an HTML file of the third-party platform (111). The script loaded from the server of the system (116) contains information of the item identity. The HTML tags with class related to the online platform are searched in order to render the voting link (110). The script loads all the application programming interfaces (API) required to render (109) the voting link (110) on the third-party platform (111) and handles the voting process through submitting a vote cast (101) through an action performed on the voting link (110) to the server of the system (116). It should be noted that any methods known in the art which allows a link to be embedded into a third-party platform (111) are applicable. The script code and the APIs are examples of a processing module for sending votes from the third-party platform (111) to the system (116). The appearance and load technique of the voting link (110) could be modified for customization purposes. Whilst it is preferred that the voting link (110) is in the form of a button, it could also be in the form of a banner or slider pop-up. A mark in the form of a name or logo identifying the online platform or the system (116) is preferred to be displayed on the voting link (110).

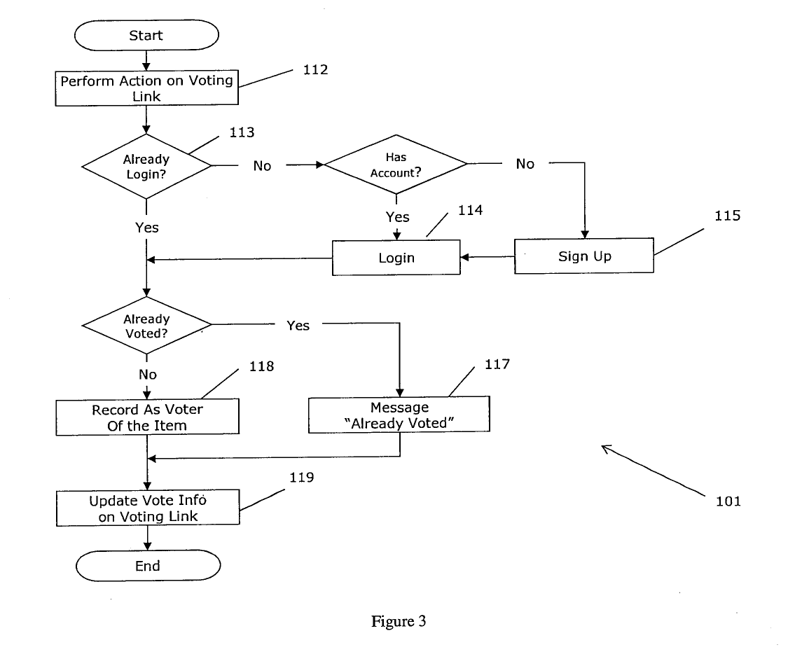

With reference to FIG. 3, the voting process is initiated through a specific action (112) performed on the voting link (110) by the user. The action (112) could be a click or a tap on the voting link (110) depending on the type of device employed by the user to browse the third-party platform (111). A request for identity authentication could be optionally set such that once the action is performed, the user would be required to sign into (114) his account which is set up in the system (116). If the user is not a member of the system (116), the user would be requested to sign up (115) for an account. In a situation where the user has voted the item previously, the voting authentication module could be configured to deter repeated votes received by the processing module from being submitted to the calculating module which is responsible for determining the value of the votes (105) by presenting a message (117) informing the user that he has voted the item before. The user is recorded as a voter of the item (118) upon his successful submission of vote. The script is then updated with the user's voting information. A processing module is configured to send the vote cast on the third-party platform (111) to the system (116) for calculating the value of the vote in order to rank the item.

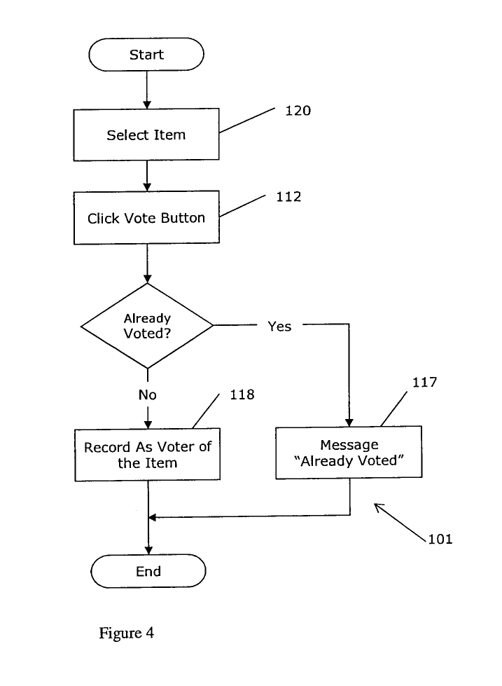

An alternative way to carry out the voting process is through voting (101) on the online platform of the system (116) directly. This method as shown in FIG. 4 requires users to be directed to the online platform for users to vote (101) directly from the online platform while they are browsing the online platform. Users can select an item and perform the action (112) on the voting link (110) which could be in the form of a button, banner or slider pop-up. If users are required to sign into (114) their account or register (115) for an account prior to accessing the content of the online platform, they would not be requested to log into (114) their account or sign up (115) for an account once more when voting from the online platform. The votes are processed similarly as to those cast from the third-party platform (111). If the user has voted a brand before, the vote of the voter would not be processed upon being identified by the voting authentication module. Else, the voter would be recorded as a voter (118) of the item and his vote would be sent to the calculating module to determine the value of his vote (105). The ranking list of the category involving the item that the voter has voted would be updated by taking his vote into account.

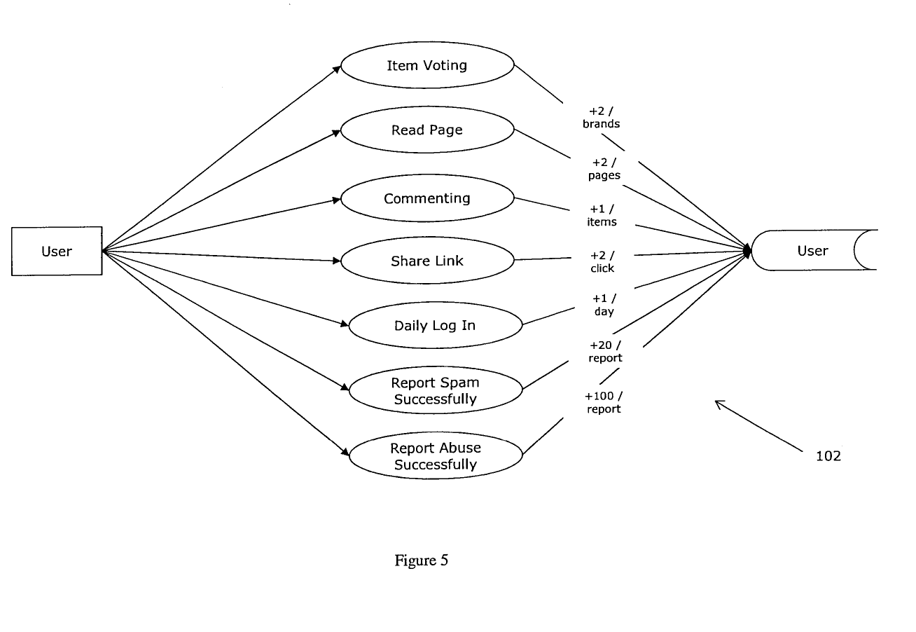

The online platform is not merely a site for displaying the rankings (108) but also a place for owners of the items to build their profiles for advertising purposes and to conduct activities to encourage interaction between owners and users. Customization of the profile pages is allowable. Profile pages for owners of each item could be established to display information related to the item. The content of information is not limited to but includes images, videos, contest, lucky draw, survey and program registration. As stated above, the votes are assigned a value each in accordance with user points gained (102, 103) or lost (104) through activities and credibility of the users. The type of user activity performed on the system (116) and the level of user activeness on the system (116) play vital roles in determining the value of votes (105). The online platform allows activities for users to participate such as commenting, voting, polling, surveying, reporting spam and abuse, sharing links, logging into account, participating lucky draws and contests, performing event registration or activation. These activities enable user points to be gained in order to add value to their votes. FIG. 5 illustrates an example of activity user points that could be gained (102) via participating in certain activities.

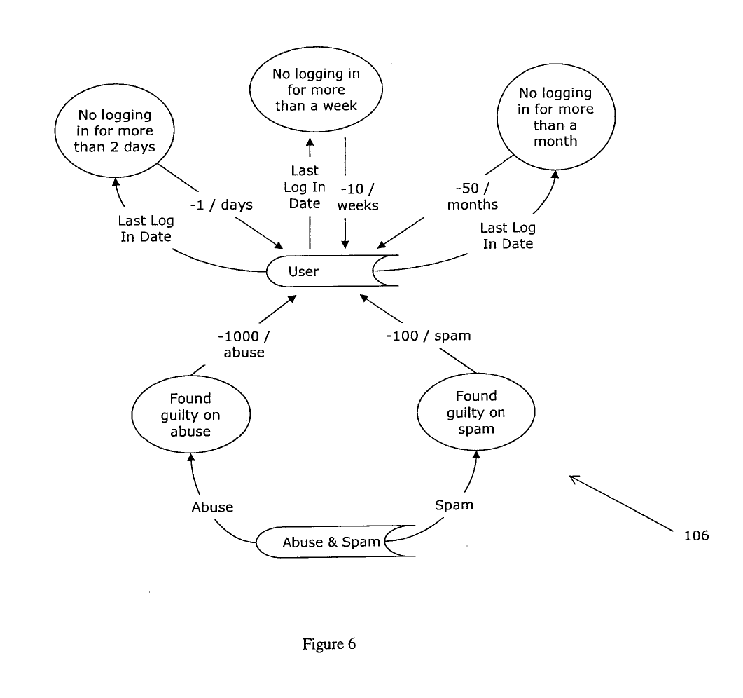

Besides adding value to the votes, it is also possible for depreciation in the value of votes to occur. This could happen if the level of user activeness has decreased such as not logging into the account for a period of time. User sign up (115), log in (114) and level of activeness are administered by an identity authentication module for deterring fake account and/or duplicate account in order to prevent fraud voting. These user activities are reported to the calculating module to determine vote value (105) of the user based on the user points. Also, wrongful or improper activities of users like spamming on item profile pages or abusing the services provided by the ranking system (116) could cause their points to be deducted (104), hence affecting the value of their votes. Examples of activities that cause depreciation of vote values to happen are depicted in FIG. 6. Administers of the system (116) could monitor the activities of users and adjust the user points via the calculating module.

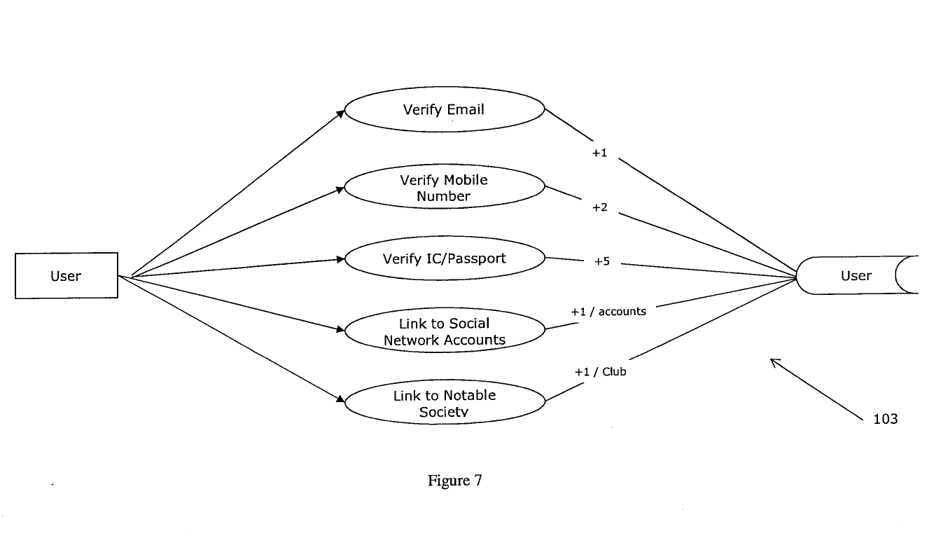

Credibility of users is also a factor in determining the value of votes. User authentication is important in proving the validity of the user for preventing fake accounts and/or duplicate accounts of users to ensure the accountability of the ranking results. Users are allowed to verify their validity through various channels or methods such as providing their email addresses, mobile numbers, identities or passports numbers, links to their social network accounts or links notable societies that they are involved in. Credibility user points are granted to users (103) who could provide more legitimate evidence to verify themselves. FIG. 7 shows an example of credibility user points that could be gained by users (103) through various verification ways. In addition to that, credibility user points could be given to users depending on their respectability and status in the society.

The identity authentication module is responsible for reporting the credibility and level of activeness in log in activities of users to the calculating module to determine the user points. Also, the calculating module is configured to add (102) or deduct (104) user points based on certain criteria such as the number of votes cast on the items of similar categories, and/or user points gained through user activity type performed on the system (116), level of user activeness on the system (116) or user creditability. The method of determining the value of votes (105) can be varied depending on the calculation methodology adopted by the calculating module.

The calculating module runs its calculating process consistently at a predetermined time. Upon calculating the value of the votes, the information of the vote values is sent to the ranking engine by the server to update and/or reposition the items on the ranking list (107). Results of the rankings reflected on the ranking list are displayed (108) on the online platform of the system (116) and are preferably updated in real-time.

Voting (101) from third-party platforms (111) is made possible by the invention described in this disclosure. The ranking system (116) provides additional channels for users to cast their votes (101) for items from a ranking list without the need to vote (101) from the online platform of the system (116) itself. Evaluation of the popularity and global presence of a certain item could be carried out based on the ranking results. The ranking system (116) is reliability focused and hence promotes value and quality voting. Furthermore, the online platform allows item owners to build their profiles and launch activities to promote their items as well as interact with users to receive feedback on the items. Owners of the items could also receive reports of infringement activities that may harm the business of the owners through the online platform.

Although the description above contains many specifications, it is understood that the embodiments of the preferred form are not to be regarded as a departure from the invention and it may be modified within the scope of the appended claims.

1-20. (canceled)

21. A system for voting and poling on a third-party platform, comprising:
at least one product list having goods or services provided by a vendor of the third-party platform;
a voting link generating module for generating a voting link that is assigned to a specific goods or services on the product list to allow a vote to be cast thereon following a specific action performed on the voting link;
a ranking engine for determining ranking of the specified goods or services through sorting the goods or services on product list upon receiving the vote;
a service platform capable of displaying at least one list showing the ranking of the product list; and
at least one server having a processor for managing processes executed by the system,
wherein the voting link is configured to be inserted and displayed on the third-party platform managed by a third-party server to readily interact and receive the specific action for the vote to be cast on the goods or services of the product list from at least one user on the third-party platform without having the user to visit the service platform of the system.

22. The system according to claim 21, further comprising a processing module configured to send the vote cast on the third-party platform to the system.

23. The system according to claim 21, further comprising an identity authentication module for deterring fake user account and/or duplicate account.

24. The system according to claim 21, further comprising a voting authentication module for preventing repeated voting.

25. The system according to claim 21, wherein the voting link is in the form of any one or combination of a button, banner or slider pop-up.

26. The system according to claim 21, wherein the service platform is any one or a combination of a website and a mobile application.

27. The system according to claim 21, wherein the third-party platform is any one or a combination of a website, email application or mobile application.

28. The system according to claim 21, wherein the voting link has a mark thereon as an identification of the service platform.

29. The system according to claim 21, wherein the vote is assigned a value that is calculated based on the number of votes cast on the goods or services of similar categories, and/or user points gained through user activity type performed on the system, level of user activeness on the system or user creditability.

30. The system according to claim 29, further comprising a calculating module for determining the value of the vote.

31. The system according to claim 21, wherein the service platform comprises a profile page for owner of each item to display information related to the goods or services on the product list.

32. The system according to claim 21, wherein the service platform enables a plurality of activities which includes any one or combination of visiting the profile page, commenting, voting, polling, surveying, reporting spam and abuse, sharing links, logging into account, participating lucky draws and contests, performing event registration or activation to be participated by the user.

33. A method for voting and poling on a third-party platform having at least one product list having goods or services provided by a vendor of a third-party platform using at least one server having a processor for managing processes executed by a system, comprising the steps of:
casting a vote that is assigned to the goods or services on the product list by at least one user through performing a specific action on a voting link inserted and displayed on the third-party platform which is managed by a third-party server;
determining ranking of the specified goods or services by a ranking engine of the system through sorting the goods or services on product list on the list upon receiving the vote; and
displaying the sorted goods or services on an service platform of the system;
wherein the voting link which is generated by a voting link generating module is configured to readily interact and receive the specific action for the vote to be cast on the specific goods or services on the product list from at least one user browsing the third-party platform without having the user to visit the service platform of the system.

34. The method according to claim 33, further comprising the step of sending the received vote to the system via a processing module.

35. The method according to claim 33, further comprising the step of requesting user verification by the identity authentication module.

36. The method according to claim 33, further comprising the step of requesting the user to log in or sign up for an account on the system for casting the vote upon performing an action on the link.

37. The method according to claim 33, further comprising the step of determining a value assigned to the vote by a calculating module of the system.

38. The method according to claim 37, wherein the value of the vote is determined based on the number of votes cast on the goods or services of similar categories, and/or user points gained through user activity type performed on the system, level of user activeness on the system or user creditability.

39. The method according to claim 33, wherein the voting link is displayed on the third-party platform through embedding a code into the third-party platform.

40. The method according to claim 33, wherein the action performed on the link is a clicking or a tapping action.
